(19) United States
(12) Patent Application Publication
(10) Pub. No.: US 2005/0210472 A1
(43) Pub. Date: Sep. 22, 2005

(54) Method and data processing system for per-chip thread queuing in a multi-processor system

(75) Inventors: Jos Manuel Accapadi, Austin, TX (US); Larry Bert Brenner, Austin, TX (US); Andrew Dunshea, Austin, TX (US); Dirk M. Michel, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/803,659

(22) Filed: Mar. 18, 2004

(51) Int. Cl. G06F 9/46

(52) U.S. Cl. 718/105

(57) ABSTRACT

A method, computer program product, and a data processing system for queuing threads among a plurality of processors in a multiple processor system having a plurality of multi-processor modules is provided. A first thread to be processed is received and is identified as part of an existing process. A search for an idle processor is performed. The search is restricted to processors of a first multi-processor module associated with the existing process.

### BACKGROUND OF THE INVENTION

1. Technical Field

The present invention relates generally to an improved data processing system and in particular to a data processing system and method for scheduling threads to be executed by processors. Still more particularly, the present invention provides a mechanism for maintaining affinity when scheduling threads to be executed by processors in a multi-processor system.

2. Description of Related Art

Multiple processor systems are generally known in the art. In a multiple processor system, a process may be shared by a plurality of processors. The process is broken up into threads which may be processed concurrently. The threads must be queued for each of the processors of the multiple processor system before they may be executed by a processor.

When a thread is dispatched to a processor, a thread context must be loaded into the processor resources for execution of the thread. Context data required for executing a thread may be distinctly associated with the thread. Such context data is referred to as a local context. Other context data required for executing a thread may be associated with all threads of a process and is referred to as a process context. Loading context data within an existing process being executed is referred to as a context switch. A process switch occurs when context data of one process is replaced with context data of anther process being prepared for execution, e.g., during a CPU flush when a currently executing process' time slice has expired. A context switch within an existing process generally consumes less time than a process switch.

The processing time required for performing context and process switches is related to the logical proximity of the processor performing the switch and the context data. A context switch consumes less processor cycles when the context switch is performed for a thread of a process being executed by the processor performing the context switch when the processor still maintains context data required for execution of the thread. This is a result of the processor resources, for example the processor's level one (L1) or level two (L2) cache, having the requisite context data maintained in near proximity to the processor. When the context data necessary for executing a thread is held by a processor's resources, e.g., the processor's L1 cache, the processor is said to have processor affinity. Assuming similarly loaded processors of equal processing capabilities, a thread can be executed more expeditiously by a processor having processor affinity than by another processor that does not have the thread's context data.

If the context data is not maintained in the processor's local resources, the processor may read the context data from the resources of a processor disposed on the same multi-processor module or chip, for example on the primary cache of a processor deployed on a common multi-processor module. Such a read incurs a larger context switch-related latency than a switch performed solely by reading context data present on the resources of the processor performing the switch. However, a context switch requiring a processor to fetch context data from the resources of a processor on the same multi-processor module is still performed more expeditiously than a context switch requiring a context fetch off the multi-processor module, for example from the resources of another multi-processor module. When the context data necessary for processing a thread is held by any resources of one or more processor's on a multi-processor module, the multi-processor module is said herein to have chip affinity. Even more latency is introduced when performing a context switch from a larger, more logically “distant” system resource, such as a level 3 (L3) cache shared between the multi-processor modules. Likewise, additional delay is introduced when performing a context switch from main memory.

One known technique for queuing threads to be dispatched to a processor in a multiple processor system is to maintain a single centralized queue, or a “global” run queue. As processors become available, they take the next thread in the queue and process it. A drawback to the global run queue approach is that a thread in the global run queue may be dispatched to a processor on a different chip module resulting in longer memory latencies and cache misses. For example, assume a thread is assigned to a global run queue in a multiple processor system having two dual-processor modules. The thread may be dispatched for execution to either processor on either dual-processor module. Further assume that a processor on a first dual-processor module is currently busy executing threads from the same process to which the globally queued thread belongs and the second processor of the first dual-processor module is idle. If the thread is dispatched to either of the processors on the second dual-processor module, and neither processor of the second processor module is executing the process to which the thread belongs, a full process switch is required for the thread to be executed on the second dual-processor module. Neither of the processors of the second dual-processor module have processor affinity with the thread, and thus the second dual-processor module does not have chip affinity with the thread. Accordingly, the context switch performed by the second processor module requires either a fetch from a level three cache shared between the first and second processor modules or a fetch from the system main memory. However, if the thread had been dispatched to the idle processor on the first processor module, the thread switch performed by the idle processor may be performed by retrieving context data from the resources of the first processor executing the thread's process. In such a situation, retrieval of context data requires either a read procedure from the first processor's primary cache or a read from a shared cache system of the first processor module—both less time consuming than a context read from a level three cache system or a main memory read due to the chip affinity of the first dual-processor module.

Global thread queuing provides no mechanism for exploiting chip affinity of a multi-processor module having two or more processors on a single chip. Rather, a global thread queuing routine schedules a thread for dispatch to the next available processor irrespective of the locality of requisite context data associated with the thread.

Another known technique for queuing threads is to maintain separate, or per-processor, local run queues for each processor. When a thread is created, it is assigned to a particular processor in a round robin manner or other similar fashion. Thread dispatch routines attempt to maintain processor affinity with a thread by queuing threads of a common process to the same local run queue. Various factors allow a thread in a local run queue to be reassigned to a queue of another processor. However, one or more processors will often go idle while another busy processor has a number of queued threads awaiting processing due to the busy processor's affinity with the queued threads. In such a situation, maintenance of the processor affinity with the queued threads can degrade the overall system performance due to the idle time incurred by the available processors. Local thread queuing routines are not adapted to exploit chip affinity resulting from the logical proximity of context data that exists between processors deployed on a common multi-processor module. Accordingly, local queuing of threads often results in inefficient utilization of processor capacity in a multi-processor system.

Simultaneous multithreading (SMT) processors allow execution of instructions of multiple threads simultaneously. SMT processors have replicate, partitioned, and shared resources for enabling the simultaneous processing of multiple threads. Because context data may be shared between thread processing units in an SMT processor, there is little, if any, performance advantage had by queuing a thread to a local run queue of a particular thread processor when either processor has context data associated with the queued thread. For example, consider an SMT processor having two thread processing units with a respective local run queue associated with each thread processing unit. Assume a first thread processing unit is executing threads of a process associated with a thread awaiting scheduling. A conventional scheduling algorithm adapted to local queue threads will recognize the thread as belonging to the process executing on the first thread processing unit. The scheduling algorithm will queue the thread to the local run queue of the first thread processing unit in an attempt to exploit the first thread processing unit's affinity with the thread. However, in an SMT environment, the second thread processing unit has access to the shared resources of the SMT CPU and thus incurs little, if any, additional latency penalty over that had by the thread processing unit executing the thread's process when retrieving the necessary context data. That is, context data is shared between the thread processing units in an SMT CPU and thus affinity of the thread processing units is inherent in the SMT processor architecture when one of the thread processing units hold a thread's context data. Thus, the processing capacity of an SMT CPU may be severely underutilized when thread scheduling is implemented according to conventional local queuing mechanisms. Additionally, global queuing in a dual or multi-SMT processor environment generally suffers similar deficiencies as those described above.

Thus, global queuing of threads in a multi-processor system provides efficient thread queuing at a potential loss of affinity with the thread. Local queuing of threads in a multi-processor system provides desirable processor affinity at a potential loss of processor utilization. Neither local or global thread queuing effectively capitalizes on the inherent chip affinity existing on a multi-processor module that results from the logical proximity of the two or more processors of the multi-processor module.

It would be advantageous to provide a thread queuing mechanism for allocating threads in a multiple processor system in a manner that advantageously balances affinity maintenance with processor utilization. It would be further advantageous to provide a mechanism for queuing threads of a process in a manner that advantageously exploits the existence of chip affinity on a multi-processor module on a per-chip basis for dual-processors, multi-processors, and SMT processors.

### SUMMARY OF THE INVENTION

The present invention provides a method, computer program product, and a data processing system for queuing threads among a plurality of processors in a multiple processor system having a plurality of multi-processor modules. A first thread to be processed is received and is identified as part of an existing process. A search for an idle processor is performed. The search is restricted to processors of a first multi-processor module associated with the existing process. Additionally, the present invention provides a method, computer program product, and a data processing system for load balancing in a multiple processor system having a plurality of multi-processor modules. An idle processor of a first multi-processor module performs a first attempt at a thread steal from a local run queue of a processor located on the first multi-processor module for reassignment of a thread to a local run queue of the idle processor. Responsive to failure of the first attempt, a second attempt at a thread steal from a dedicated queue associated with a second multi-processor module is performed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented in accordance with a preferred embodiment of the present invention;

FIG. 3 is an exemplary diagram of a multiple processor system in which a preferred embodiment of the present invention may be implemented;

FIG. 4 is a diagrammatic illustration of a multi-run queue system in accordance with a preferred embodiment of the present invention;

FIG. 5 is a diagrammatic illustration of the multi-processor system of FIG. 3 illustrating an initial load balancing routine implemented according to a preferred embodiment of the present invention;

FIG. 6 is a diagrammatic illustration of the multi-processor system of FIG. 3 during initial load balancing when a new thread of an existing process is received for queuing in accordance with a preferred embodiment of the present invention;

FIG. 7 is a diagrammatic illustration of a multi-processor module of the multi-processor system of FIG. 3 having a processor becoming idle during idle load balancing performed in accordance with a preferred embodiment of the present invention;

FIG. 8 is a diagrammatic illustration of the multi-processor system of FIG. 3 during idle load balancing when an inter-module thread steal is performed in accordance with a preferred embodiment of the present invention;

FIG. 9 is a diagrammatic illustration of the multi-processor system of FIG. 3 when periodic load balancing is performed in accordance with a preferred embodiment of the present invention;

FIG. 10 is a flowchart of processing performed during initial load balancing in accordance with a preferred embodiment of the present invention;

FIG. 11 is a flowchart of intra-module idle load balancing processing performed in accordance with a preferred embodiment of the present invention;

FIG. 12 is a flowchart of inter-module idle load balancing performed in accordance with a preferred embodiment of the present; invention; and

FIG. 13 is a flowchart of periodic load balancing processing performed in accordance with a preferred embodiment of the present invention.

### DETAILED DESCRIPTION OF THE PREFERRED EMBODIMENT

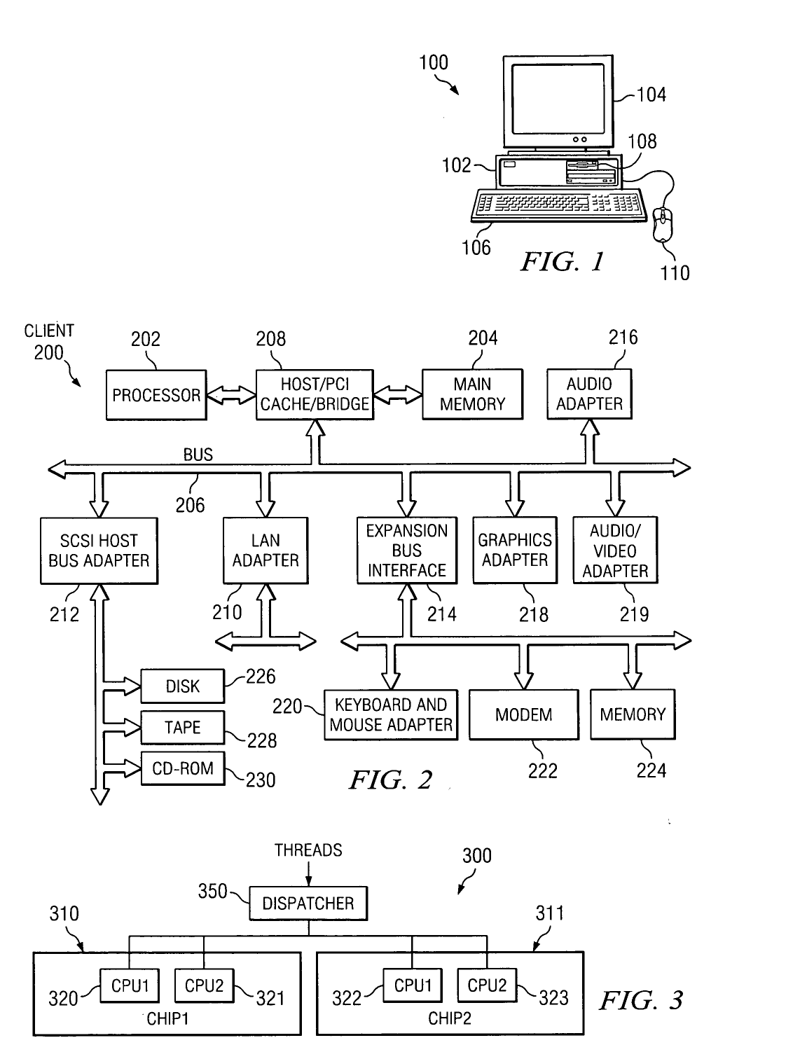

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor system 202 and main memory 204 are connected to PCI local bus 206 through PCI bridge 208. PCI bridge 208 also may include an integrated memory controller and cache memory for processor system 202. Processor system 202 is representative of a multiple processor system having two or more multi-processor modules such as a dual-processor module, a multi-processor module, or dual or multi-SMT processors. Additional connections to PCI local bus 206 may be made through direct component interconnection or through add-in connectors. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor system 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor system 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. The depicted example in FIG. 2 and above-described examples are not meant to imply architectural limitations.

The processes of the present invention are performed by processor system 202 using computer implemented instructions, which may be located in a memory such as, for example, main memory 204, memory 224, or in one or more peripheral devices 226-230.

FIG. 3 is an exemplary diagram of a multi-processor (MP) system 300 in which a preferred embodiment of the present invention may be implemented. MP system 300 is an example of a data processing system, such as data processing system 200 in FIG. 2. As shown in FIG. 3, MP system 300 includes dispatcher 350 and a plurality of processors 320-323. Dispatcher 350 assigns threads to processors in system 300. Although dispatcher 350 is shown as a single centralized element, dispatcher 350 may be distributed throughout MP system 300. For example, dispatcher 350 may be distributed such that a separate dispatcher is associated with each processor 320-323 or a group of processors, such as processor deployed on a common chip. Furthermore, dispatcher 350 may be implemented as software instructions run on processor 320-323 of the MP system 300.

MP system 300 may be any type of system having a plurality of multi-processor modules. As used herein, the term “processor” refers to either a central processing unit or a thread processing core of an SMT processor. Thus, a multi-processor module is a processor module having a plurality of processors, or (CPUs), deployed on a single chip, or a chip having a single CPU capable of simultaneous execution of multiple threads, e.g., an SMT CPU or the like. In the illustrative example, processors 320 and 321 are deployed on a single multi-processor module 310, and processors 322 and 323 are deployed on a single multi-processor module 311. As referred to herein; processors on a single multi-processor module, or chip, or said to be adjacent. Thus, processors 320 and 321 are adjacent, as are processors 322 and 323.

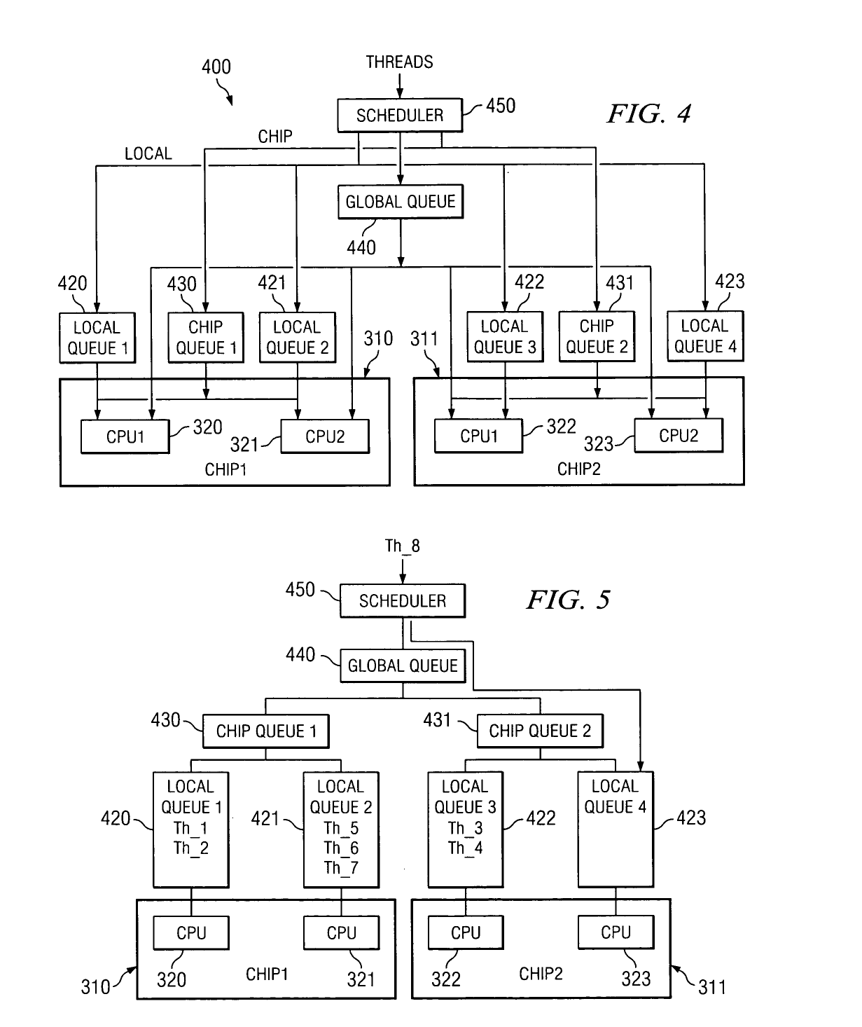

FIG. 4 is a diagrammatic illustration of a multi-run queue system 400 from which threads are dispatched in MP system 300 of FIG. 3 in accordance with a preferred embodiment of the present invention. Each processor, such as processors 320-323, has a respective local run queue, such as local run queues, 420-423, and system 400 has an associated global run queue 440. Additionally, chip run queues 430 and 431 are allocated on a per-chip basis. That is, chip run queues 430 and 431 are dedicated to respective multi-processor modules 310 and 311. Threads are selected for placement in a local, chip, or global run queues by scheduler 450. Each of processor 320-323 services a respective single local run queue 420-423 and processors 320-323 collaboratively service global run queue 440. Processors deployed on a common chip, for example processors 320 and 321, service chip run queue 430. Likewise, processors 322 and 323 deployed on multi-processor module 311 service chip run queue 431.

The global, local, and chip run queues are populated by threads. A thread comprises instructions of a process. As used herein, the term process refers to a set of related instructions to be executed, for example instructions of a computer program. A process comprises at least one thread. Associated with a process is data referred to as a context. A context is various process state information such as register contents, program counters, and flags. Processes are typically made up of multiple threads, and each thread may have its own local context data as well as process context data shared among multiple threads of the process.

Multi-processor modules 310 and 311 allow execution of two threads simultaneously. Threads in global run queue 440 may be serviced by any of processors 320-323, while threads in chip run queues 430 and 431 may be serviced by processors 320-321 and 322-323, respectively. A thread in one of local run queues 420-423 is processed by an associated processor 320-323. Threads that are present in the queues seek processing time from processors 320-323 and thus compete on a priority basis for the processors' resources.

The present invention provides chip run queues for dispatching threads on a per-chip basis. Queuing a thread on a per-chip basis in accordance with the present invention allows a processor to expeditiously obtain process or thread context data from another processor located on the same chip thereby advantageously exploiting chip affinity in a manner not achievable by a global queuing mechanism. Additionally, per-chip queuing provides a smaller logical processor base for dispatching a thread than that achieved in a global queuing arrangement thereby reducing the idle processor search and dispatch time. Additionally, per-chip thread queuing provides an advantage over local run queues by better utilizing processor resources while maintaining affinity with a thread.

Threads to be scheduled for processing may be bound or unbound. As referred to herein, a bound thread is a thread required to be processed by a specific processor, and an unbound thread is a thread that is not required to be processed by a particular processor. A bound thread has an associated identifier read by the scheduler that indicates the particular processor to which the thread is bound. If a thread is bound to a specific processor, it must be queued to the local run queue of the processor to which the thread is bound. In accordance with the present invention, an unbound thread may be scheduled in a chip run queue associated with a multi-processor module determined to hold context data associated with the thread, that is either local or process context data of the thread. As referred to herein, a multi-processor module is said to hold context data if a resource associated with a processor of the multi-processor module holds the context data, or if a shared resource of the processors of the multi-processor module holds the context data.

Scheduler 450 identifies a queue for assignment of a new thread upon receipt of the new thread. Additionally, scheduler 450 may be invoked by an idle processor in an attempt to obtain a thread by the idle processor. Threads are added to run queues based on load balancing among the processors 320-323. The load balancing may be performed by scheduler 450. Load balancing includes a number of methods of keeping the various run queues of MP system 300 equally utilized. Load balancing, according to the present invention, may be viewed as initial load balancing, idle load balancing, and periodic load balancing.

For illustrative purposes, assume the threads (Th_1-Th_14) shown in FIGS. 5-9 are part of the processes (Process_1-Process_4) according to table A below:

TABLE A

| | |
|---|---|
| Process_1 | Th_1 |
| | Th_2 |
| | Th_9 |
| Process_2 | Th_3 |
| | Th_4 |
| Process_3 | Th_5 |
| | Th_6 |
| | Th_7 |
| Process_4 | Th_8 |
| | Th_10 |
| | Th_11 |
| | Th_12 |
| | Th_13 |
| | Th_14 |

Initial load balancing is the spreading of the workload of new threads across the run queues at the time the new threads are created. FIG. 5 is a diagrammatic illustration of MP system 300 illustrating the initial load balancing method implemented according to a preferred embodiment of the present invention. When an unbound new thread TH_8 is created as part of a new process, or job, scheduler 450 attempts to place the thread in a local run queue associated with an idle processor. To do this, scheduler 450 performs a round-robin search among all processors 320-323 of MP system 300. If an idle processor is found, the new thread TH_8 is assigned to the local run queue of the idle processor.

The round robin search begins with the local run queue, in the sequence of local run queues, that falls after the local run queue to which the last new thread was assigned. The round robin technique searches processors of a common multi-processor module before progressing to processors of another multi-processor module. The search preferably begins by searching processors external from the multi-processor module having the processor to which the last new thread was assigned. As referred to herein, a processor or an associated local run queue is said to be external to another processor, the other processor's associated local run queue, and the other processor's multi-processor module if the two processors are located on different multi-processor modules. In this way, the method assigns new threads of a new process to idle processors while continuing to spread the threads out across all of the processors of multi-processor modules 310 and 311.

In the illustrative example, assume thread TH_7 was the last thread assigned to a run queue by scheduler 450. Thus, applying the round robin technique to MP system 300 shown in FIG. 5, the scheduler begins the idle processor search with the processors of multi-processor module 311. In the present example, processor 322 is busy and processor 323 is idle. Thus, the new thread TH_8 is assigned to local run queue 423 associated with idle processor 323. When the next new thread is created, the round-robin search for an idle processor will start with processor 320 of multi-processor module 310 and local run queue 420. The search will progress through each of processors 320 and 321 and respective local run queues 420 and 421 before returning to processors 322 and 323 and respective local run queues 422 and 423 until an idle processor is encountered or each local run queue has been searched. Failure to identify an idle processor after completing the round-robin search for a new thread of a new process preferably results in assignment of the new thread to global run queue 440 where the new thread awaits availability of an idle processor. At such time, the new thread is reassigned from global run queue 440 to the local run queue associated with the newly idle processor.

When an unbound thread is created as part of an existing process, scheduler 450 again attempts to assign the unbound thread to the local run queue of the idle processor if one exists. However, the processor search is restricted to multi-processor module(s) having a processor to which one or more threads of the new thread's process has been assigned. The search is restricted in this manner in an attempt to assign the new thread to a local run queue of an idle processor that has recently executed a thread of the new thread's process, or alternatively to assign the new thread to a chip run queue of a multi-processor module having a processor that has recently executed a thread of the new thread's process. The search will assign the thread to the local run queue of a processor if an idle processor is found. If no processor of the multi-processor module is idle, the thread is assigned to the chip run queue of the multi-processor module. In doing so, chip affinity with the new thread is ensured.

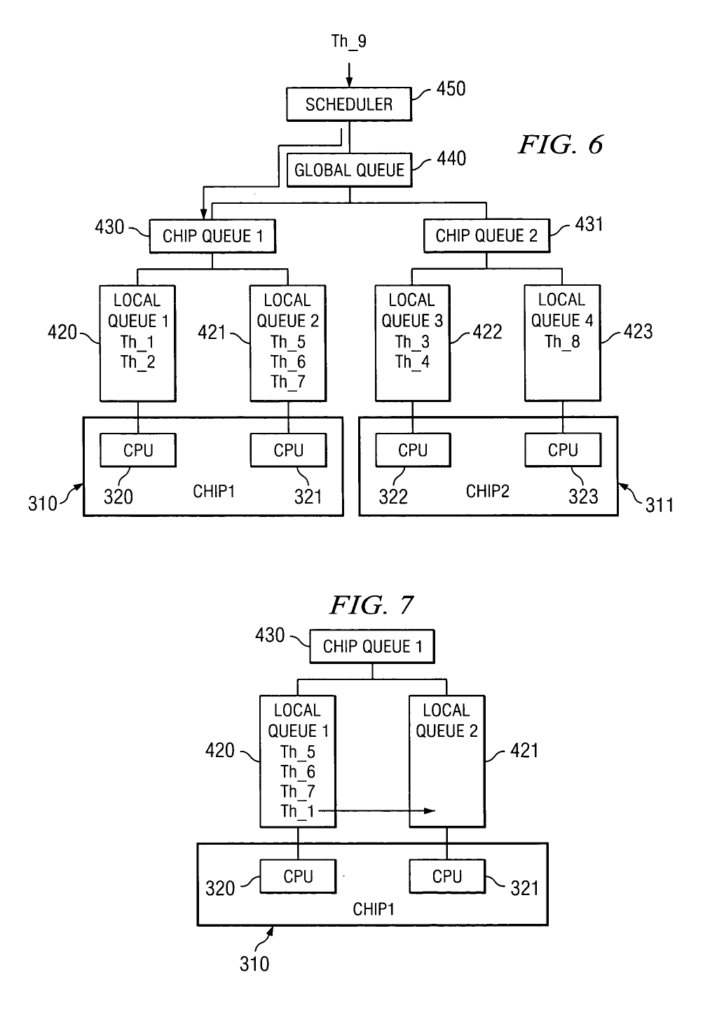

FIG. 6 is a diagrammatic illustration of MP system 300 showing initial load balancing when a new thread of an existing process is received for queuing in accordance with a preferred embodiment of the present invention. Applying the round-robin technique to MP system 300 shown in FIG. 6, scheduler 450 evaluates a new thread TH_9 as belonging to Process_1. Accordingly, only processors 320 and 321 and respective local run queues 420 and 421 are searched because neither of processors 322 and 323 have any threads of Process_1 to which thread TH_9 belongs. In the illustrative example, neither processor 320 or 321 is idle. Accordingly, scheduler 450 assigns new thread Th_9 to chip run queue 430. When one of processors 320 or 321 becomes idle, thread Th_9 may then be placed in the idle processor's local run queue.

With the above initial load balancing method, unbound new threads of a new process are dispatched quickly, either by assigning them to a local run queue of a presently idle CPU or by assigning them to a global run queue. Threads on a global run queue will tend to be dispatched to the next available processor, priorities permitting. Unbound new threads of an existing process are assigned to a local run queue associated with an idle processor of a multi-processor module having the new thread's process or, alternatively, to a chip run queue associated with the multi-processor module having the new thread's process.

In addition to initial load balancing, idle load balancing and periodic load balancing are performed to ensure balanced utilization of system resources.

Idle load balancing applies when a processor would otherwise go idle and scheduler 450 attempts to shift the workload from other processors onto the potentially idle processor. In accordance with a preferred embodiment of the present invention, an idle load balancing routine takes into account processor or chip affinity of threads in local run queues or chip run queues when determining whether a thread is to be reassigned from one queue to another queue.

If a processor is about to become idle, scheduler 450 attempts to steal, or reassign, threads from other local run queues of the multi-processor module having the potentially idle processor. Scheduler 450 scans the local run queues of the multi-processor module having the potentially idle processor for a local run queue that satisfies the following intra-module thread steal criteria:
1) the local run queue has the largest number of threads of all the local run queues of the multi-processor module;
2) the local run queue contains more threads than the multi-processor module's current intra-module steal threshold (defined hereinbelow); and
3) the local run queue contains at least one unbound thread.

If a local run queue meeting these criteria is found, scheduler 450 steals an unbound thread from that local run queue and reassigns the thread to the local run queue of the potentially idle processor. Reassignment of a thread from one local run queue of a multi-processor module to another local run queue of the same multi-processor module is referred to herein as an intra-module thread steal.

Idle load balancing is constrained by the multi-processor module's intra-module steal threshold. An intra-module steal threshold may be implemented as a fraction of an average load factor on all the local run queues of all processors on the multi-processor module. The load factor may, for example, be determined by sampling the number of threads on each local run queue at every clock cycle or at periodic intervals.

For example, if the load factors of processors 320 and 321 are 14 and 10 over a period of time, the average load factor may be calculated as 12. The intra-module steal threshold may be, for example, ¼ of the average load factor and thus is calculated as 3. The intra-module steal threshold (¼ in this example) is preferably a tunable value.

Accordingly, the local run queue from which threads are to be stolen must have more than 3 threads in the local run queue, at least one of which must be an unbound thread and thus stealable. The local run queue must also have the largest number of threads of all of the local run queues of the associated multi-processor module.

FIG. 7 is a diagrammatic illustration of a multi-processor module 310 of MP system 300 of FIG. 3 having a processor becoming idle during idle load balancing performed in accordance with a preferred embodiment of the present invention. Processor 321 is becoming idle and its associated local run queue 421 and chip run queue 430 have no assigned threads. Thus, idle processor 321 attempts to steal a thread from local run queue 420 of processor 320 commonly located with processor 321 on multi-processor module 310.

Taking the above steal criteria into consideration and assuming at least one of the threads in local run queue 420 is unbound, local run queue 420 satisfies the above intra-module thread steal criteria. That is, local run queue 420 has more threads than the intra-module steal threshold, has the most threads of all local run queues associated with multi-processor module 310, and has at least one unbound thread. In the illustrative examples, a thread steal is indicated by an arrow from a thread to be stolen to the queue to which the stolen thread is reassigned. Hence, an unbound thread in local run queue 420 is stolen. For example, a run queue pointer of an unbound thread of local run queue 420 may be reassigned to the run queue pointer of local run queue 421.

If a thread is unable to be stolen on an intra-module thread steal basis, scheduler 450 may steal a thread from an external chip or local run queue of another multi-processor module. An inter-module thread steal may be performed from an external chip run queue when the following criteria are satisfied:
1) the chip run queue has the largest number of threads of all the chip run queues of the MP system;
2) the chip run queue contains more threads than the multi-processor module's current inter-module thread steal threshold (defined hereinbelow).

Likewise, an inter-module thread steal may be performed from a local run queue when no threads are available in the chip run queue of a processor from which a thread is to be stolen when the following inter-module thread steal criteria are satisfied:
1) the local run queue has the largest number of threads of all the local run queues of the multi-processor module from which the thread is to be stolen;
2) the local run queue contains more threads than the external multi-processor module's current inter-module thread steal threshold.

Idle load balancing performed between multi-processor modules is constrained by the multi-processor module's inter-module thread steal threshold. The inter-module thread steal threshold may be implemented as a fraction of an average load factor on all the local run queues and the chip run queue of the multi-processor module from which the thread is to be stolen. The inter-module thread steal threshold may be, for example, ⅓ of the average load factor of the multi-processor module. Preferably, the inter-module thread steal threshold is a tunable value.

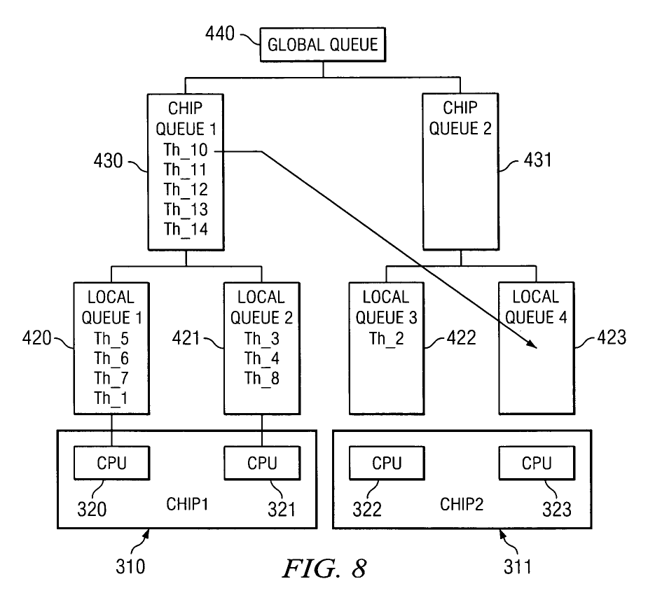

FIG. 8 is a diagrammatic illustration of MP system 300 of FIG. 3 during idle load balancing when an inter-module thread steal is performed in accordance with a preferred embodiment of the present invention. For illustrative purposes, assume thread Th_2 is bound to processor 322 and is thus not stealable by idle processor 323. Accordingly, scheduler 450 attempts to steal a thread from chip run queue 430 or local run queues 420 and 421 each associated with external multi-processor module 310.

Local run queues 420 and 421 and chip run queue 430 have respective thread loads of 4, 3 and 5 and thus an average load factor of 4. The inter-module thread steal threshold is thus 4/3 and run queue 430 must have at least two threads to allow a thread to be stolen. The illustrative MP system 300 has only two chip run queues and, accordingly, the load of chip run queue 430 is the largest in the multi-processor system thus satisfying the first criteria of the inter-module thread steal criteria. Additionally, the chip run queue has more threads than the inter-module thread steal threshold of multi-processor module 310. Thus, an inter-module thread steal is executed and a thread is stolen from chip run queue 430 of multi-processor module 310 and is reassigned to local run queue 423 of idle processor 323. If the inter-module thread steal from chip run queue 430 had failed, scheduler 450 may then have attempted an inter-module thread steal from one of local run queues 420 and 421. By first attempting a thread steal from an inter-module chip run queue before attempting a thread steal from an inter-module local run queue, threads assigned to a chip run queue potentially having less resource affinity than threads in a local run queue are first targeted for a thread steal.

Periodic load balancing is performed every N clock cycles and attempts to balance the workloads of the local run queues and chip run queues in a manner similar to that of idle load balancing. However, periodic load balancing is performed when, in general, all the processors are loaded.

Periodic load balancing involves scanning local run queues and chip run queues to identify queues having the largest and smallest number of assigned threads on average. Periodic load balancing may be performed by intra- or inter-module thread steals. Preferably, periodic load balancing between local run queues associated with processors of a common multi-processor module is performed by comparison of local run queue load factors. For example, load factors may be calculated for adjacent local run queues associated with processors of a common multi-processor module. If the difference in load factors between adjacent local run queues is above a predetermined periodic local load balancing threshold, such as 1.5 for example, intra-module periodic load balancing may be performed by executing an intra-module local run queue thread steal. If the difference between the load factors of the adjacent local run queues is less than the periodic local load balancing threshold, it is determined that the workloads of the processors are well balanced and periodic intra-module load balancing between adjacent processors is not performed.

In a similar manner, inter-module periodic load balancing between chip run queues may be performed by comparison of chip run queue load factors. Preferably, the threshold for allowing a thread steal between chip run queues is higher than the threshold for allowing thread steals between local run queues associated with processors of a common multi-processor module. This is due to the potential loss of chip affinity that may occur when stealing threads from one chip run queue for assignment to another chip run queue. For example, if the difference in chip run queue load factors is above a predetermined periodic chip balancing threshold, such as 3 for example, inter-module periodic load balancing between chip run queues may be performed by executing an inter-module chip run queue thread steal. If the difference in chip run queue load factors is less than the periodic chip balancing threshold, it is determined that the workloads of the multi-processor modules are well balanced and periodic inter-module load balancing is not performed.

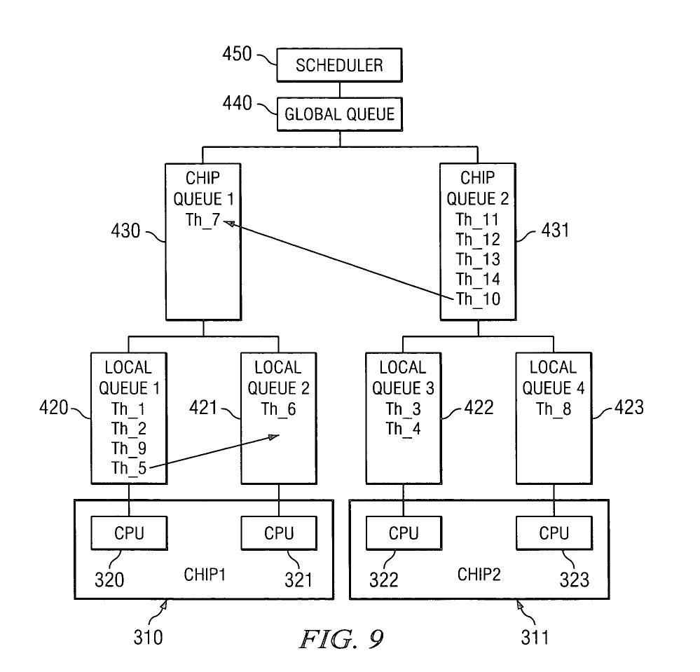

FIG. 9 is a diagrammatic illustration of MP system 300 of FIG. 3 when periodic load balancing is performed in accordance with a preferred embodiment of the present invention. As shown, each of processors 320-323 is busy processing threads in their respective local run queues 420-423. However, the workloads among processors 320-323 are not well balanced. Periodic load balancing attempts to balance the work loads among local run queues of processors on a common multi-processor module as well as perform load balancing among chip run queues associated with different multi-processor modules.

In the illustrative example, the load factor for local run queue 420 is 4 and the load factor for local run queue 421 is 1. The difference between the load factors of local run queues 420 and 421 exceeds the periodic local load balancing threshold of 1.5. Hence, a thread of local run queue 420 is stolen by reassigning a thread of local run queue 420 to local run queue 421.

The load factors of local run queues 422 and 423 are 2 and 1, respectively. Accordingly, processors 322 and 323 are determined to be well balanced and no periodic load balancing is required between local run queues 422 and 423.

Additionally, chip run queues 430 and 431 have load factors of 1 and 5, respectively. The difference between load factors of chip run queues 430 and 431 exceeds the periodic chip balancing threshold. Accordingly, a thread is stolen from the most heavily loaded chip run queue 431 and is reassigned to the most lightly loaded chip run queue 430.

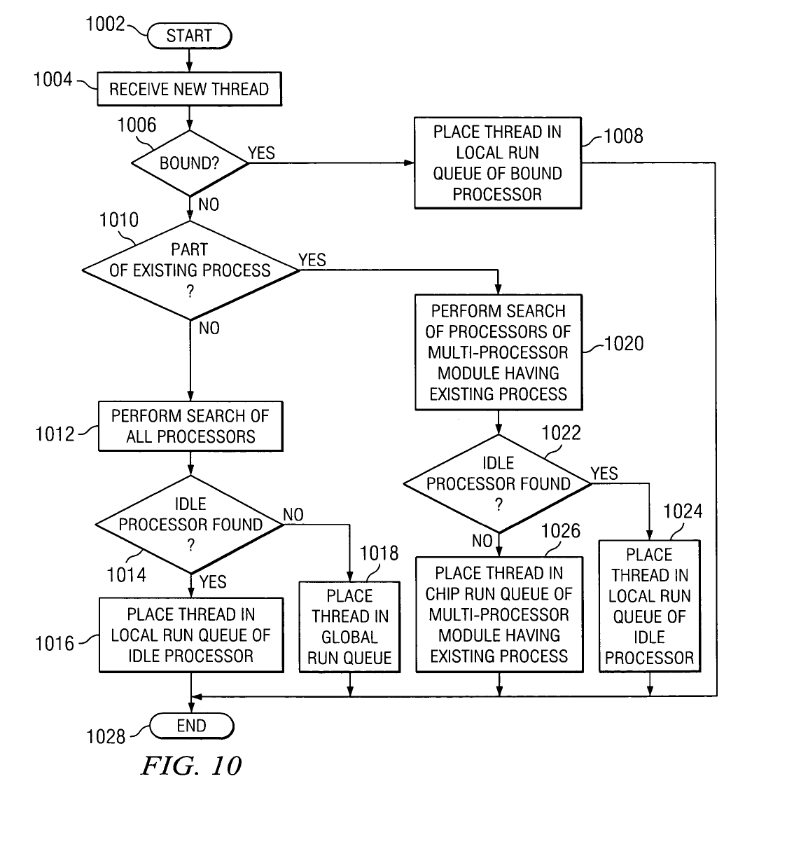

FIG. 10 is a flowchart of processing performed by scheduler 450 when performing initial load balancing in accordance with a preferred embodiment of the present invention. The initial load balancing routine starts (step 1002) and scheduler 450 awaits receipt of a new thread (step 1004) to be assigned to a thread queue.

Scheduler 450 determines if the new thread is a bound or unbound thread (step 1006). This may be performed by reading attribute information associated with the thread indicating whether or not the thread is bound to a particular processor. If the thread is bound, scheduler 450 places the new thread in the local run queue associated with the bound processor (step 1008).

If scheduler 450 determines the new thread is unbound at step 1006, scheduler 450 evaluates whether the new thread is part of an existing process (step 1010). An evaluation of whether the new thread is part of an existing process may be performed by reading attribute information associated with the new thread. A search for an idle processor among all MP system 300 processors is made if the new thread is not part of an existing process (step 1012). Scheduler 450 then determines whether or not an idle processor has been found (step 1014) and places the new thread in the local run queue of the idle processor if one is found (step 1016). If an idle processor is not found among all MP system 300 processors, the new thread is placed in the global run queue (step 1018).

If the new thread is evaluated as part of an existing process at step 1010, a search for an idle processor restricted to the processors of the multi-processor module to which other threads of the existing process were assigned is made (step 1020). Scheduler 450 then determines whether or not an idle processor of the multi-processor module having the existing process has been found (step 1022) and places the new thread in the local run queue of the idle processor if one is found (step 1024). Alternatively, the new thread is placed in the chip run queue of the multi-processor module having the existing thread if no idle processor is found (step 1026). When the thread is placed in a run queue, the thread queuing routine exits (step 1028).

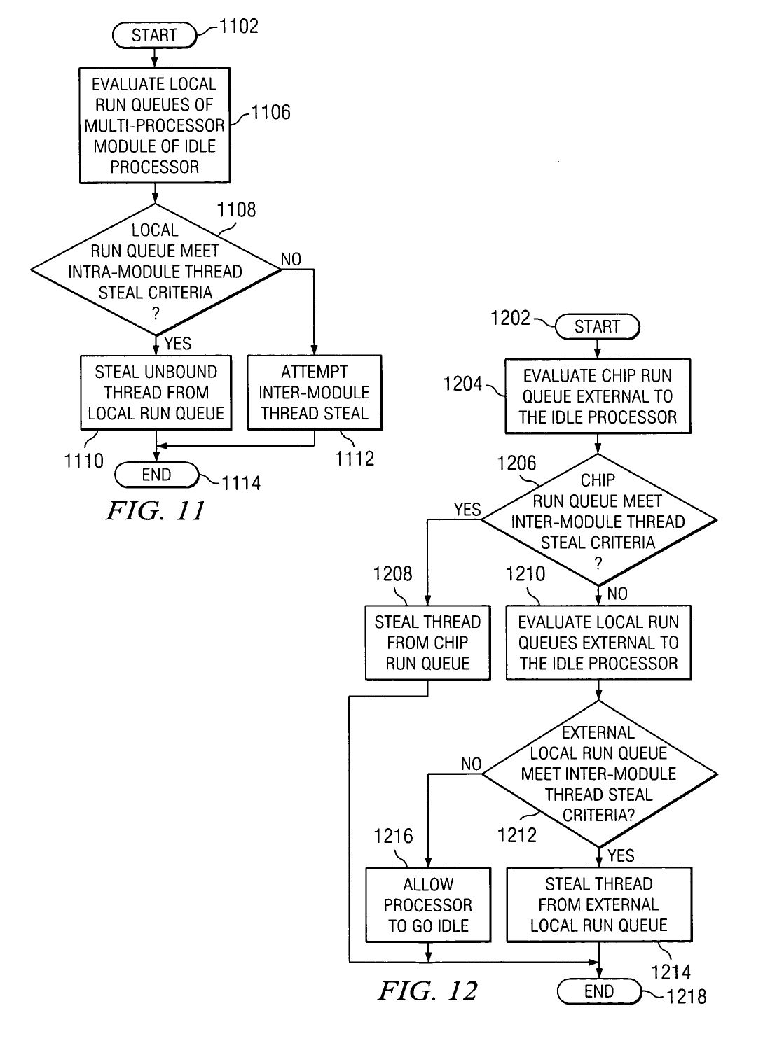

FIG. 11 is a flowchart of processing performed by scheduler 450 when performing intra-module idle load balancing in accordance with a preferred embodiment of the present invention. The idle load balancing routine starts (step 1102) and scheduler 450 then evaluates the local run queues of adjacent processor(s) of the multi-processor module having the processor becoming idle (step 1106). Scheduler 450 determines if any of the adjacent local run queues meet the intra-module thread steal criteria (step 1108). If an adjacent local queue is found that meets the intra-module thread steal criteria, an unbound thread of the local run queue meeting the intra-module thread steal criteria is stolen and reassigned to the local run queue of the idle processor (step 1110). If no adjacent local run queue is found meeting the intra-module thread steal criteria at step 1108, an inter-module thread steal is attempted (step 1112) in accordance with FIG. 12 discussed below and the intra-module thread steal routine exits (step 1114).

FIG. 12 is a flowchart of processing performed by scheduler 450 when attempting an inter-module thread steal during idle load balancing in accordance with a preferred embodiment of the present invention. The inter-module thread steal routine starts (step 1202) and scheduler 450 evaluates a chip run queue external to the multi-processor module having the idle processor (step 1204). An evaluation of the external chip run queue is made by scheduler 450 to determine if the external chip run queue meets the inter-module thread steal criteria (step 1206). A thread of the external chip run queue is stolen and reassigned to the local run queue of the idle processor if the external chip run queue is determined to meet the inter-module thread steal criteria (step 1208).

Local run queues of processors external to the multi-processor module having the idle processor are evaluated (step 1210) if it is determined that the external chip run queue fails to meet the inter-module steal criteria at step 1206. Scheduler 450 then determines if any of the external local run queues meet the inter-module thread steal criteria (step 1212). A thread is stolen from an external local run queue and is reassigned to the local run queue of the idle processor (step 1214) if an external local run queue is determined to meet the inter-module thread steal criteria. Alternatively, the processor is allowed to go idle (step 1216) if none of the external local run queues are determined to meet the inter-module thread steal criteria at step 1212. The inter-module thread steal routine then exits (step 1218).

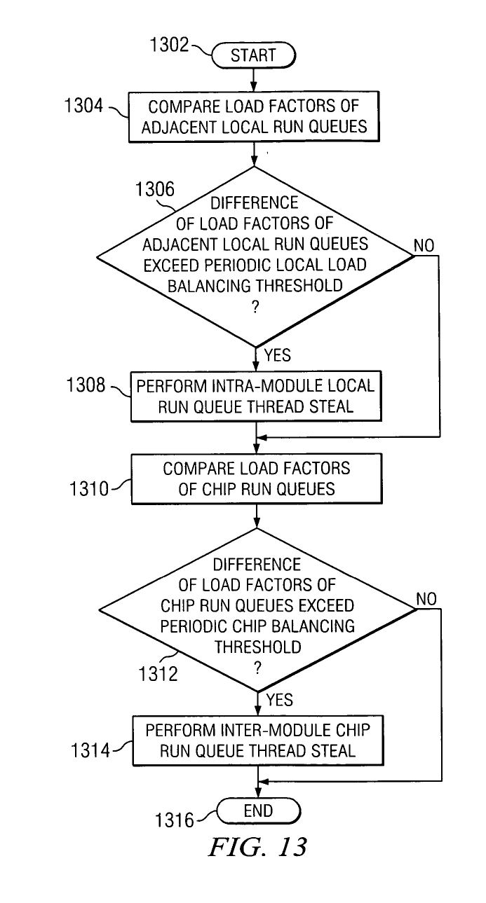

FIG. 13 is a flowchart of processing performed by scheduler 450 when performing periodic load balancing in accordance with a preferred embodiment of the present invention. The periodic load balancing routine begins (step 1302) and scheduler 450 compares load factors of adjacent local run queues (step 1304). Scheduler 450 determines if the difference between load factors of adjacent local run queues exceeds the periodic local load balancing threshold (step 1306). If the difference in the load factors of adjacent local run queues does not exceed the periodic local load balancing threshold, the periodic load balancing routine proceeds to step 1310. Alternatively, if scheduler 450 determines the difference between the load factors of adjacent local run queues exceeds the periodic local load balancing threshold, an intra-module local run queue thread steal is performed (step 1308).

Inter-module period load balancing is performed by comparing load factors of chip run queues (step 1310). Scheduler 450 determines if the difference between load factors of chip run queues exceeds the periodic chip balancing threshold (step 1312). The periodic load balancing routine exits (step 1316) if the difference in load factors of the chip run queues does not exceed the periodic chip balancing threshold. An inter-module chip run queue thread steal is performed (step 1314) if scheduler 450 determines the difference between the chip load factors exceeds the periodic chip balancing threshold, and the periodic load balancing routine then exits (step 1316).

As described, the present invention provides a thread queuing routine for allocating threads in a multi-processor system in a manner that advantageously balances chip affinity with processor utilization. The per-chip thread queuing method advantageously exploits the existence of process context data maintained on a multi-processor module on a per-chip basis for dual-, multi-, and SMT processors. Chip affinity is maintained by ensuring the thread is dispatched to a processor on a chip identified as having context data associated with the thread. Thus, the chip run queue provides a smaller logical base of processors to be searched for dispatch of a queued thread to a processor than does a global queuing mechanism. Memory latencies and cache misses are reduced compared to a global queuing routine.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of queuing threads among a plurality of processors in a multiple processor system having a plurality of multi-processor modules, the method comprising the computer implemented steps of:
receiving a first thread to be processed;
identifying the first thread as part of an existing -process; and
performing a search for an idle processor, wherein the search is restricted to processors of a first multi-processor module associated with the existing process.

2. The method of claim 1, further comprising:
assigning the first thread to a queue dedicated to the first multi-processor module.

3. The method of claim 2, further comprising:
identifying the first multi-processor module as associated with the existing process.

4. The method of claim 3, wherein the step of identifying the first multi-processor module further comprises:
maintaining a record of processes having threads executed by a processor of the first multi-processor module during a predetermined preceding interval.

5. The method of claim 1, further comprising:
identifying one of the processors as an idle processor; and
assigning the first thread to a local run queue associated with the idle processor.

6. The method of claim 1, wherein the step of identifying further comprises:
reading attribute information of the first thread.

7. A method of load balancing in a multiple processor system having a plurality of multi-processor modules, the method comprising the computer implemented steps of:
performing, by an idle processor of a first multi-processor module, a first attempt at a thread steal from a local run queue of a processor located on the first multi-processor module for reassignment of a thread to a local run queue of the idle processor; and
responsive to failure of the first attempt, performing a second attempt at a thread steal from a dedicated queue associated with a second multi-processor module.

8. The method of claim 7, further comprising:
evaluating a criterion associated with the second multi-processor module; and
responsive to evaluating the criterion, determining if a thread is to be reassigned from the dedicated queue to the local run queue of the idle processor.

9. The method of claim 7, further comprising:
reassigning a thread of the dedicated queue to the local run queue of the idle processor.

10. The method of claim 7, further comprising:
responsive to failure of the second attempt, performing a third attempt at a thread steal from a local run queue associated with a processor of the second multi-processor module for reassignment of a thread to the local run queue of the idle processor.

11. A method of load balancing processors in a multiple processor system having a plurality of multi-processor modules, the method comprising the computer implemented steps of;
comparing a thread load of a first queue dedicated to a first multi-processor module with a thread load of a second queue dedicated to a second multi-processor module; and
reassigning a thread of the first queue to the second queue.

12. The method of claim 11, wherein the step of comparing further comprises:
determining a difference between the thread load of the first queue and the thread load of the second queue, reassigning the thread responsive to evaluating the difference as greater than a threshold.

13. A computer program product in a computer readable medium for queuing threads in a multiple processor system having a plurality of multi-processor modules, the computer program product comprising:
first instructions for receiving a first thread to be processed; and
second instructions for assigning the first thread to a first queue dedicated to a first multi-processor module of a plurality of multi-processor modules.

14. The computer program product of claim 13, further comprising:
third instructions for identifying a process associated with the first thread, wherein the second instructions identify threads of the process assigned to the first multi-processor module.

15. The computer program product of claim 13, further comprising:
third instructions for comparing a thread load of the first queue with a thread load of a second queue dedicated to a second multi-processor module of the plurality of multi-processor modules; and
fourth instructions for reassigning the first thread to the second queue.

16. The computer program product of claim 13, further comprising:
third instructions for reassigning the first thread to a second queue dedicated to a processor of a second multi-processor module of the plurality of multi-processor modules.

17. A multiple processor data processing system for executing multi-threaded processes, comprising:
a memory that contains a scheduler as a set of instructions;
a first multi-processor module; and
a second multi-processor module, wherein the scheduler, responsive to execution of the set of instructions, is adapted to receive a thread and assign the thread to a queue dedicated to the first multi-processor module.

18. The data processing system of claim 17, wherein the first multi-processor module comprises a plurality of central processing units disposed on a first chip, and the second multi-processor module comprises a plurality of central processing units disposed on a second chip.

19. The data processing system of claim 17, wherein the first multi-processor module is a simultaneous multi-threading central processing unit, and the second multi-processor module is a simultaneous multi-threading central processing unit.

20. The data processing system of claim 17, wherein the scheduler identifies a second thread of a process associated with the first thread, and the second thread is assigned to the queue.
